(19) United States
(12) Patent Application Publication
(10) Pub. No.: US 2021/0027347 A1
(43) Pub. Date: Jan. 28, 2021

(54) SYSTEMS AND METHODS FOR OPTIMIZING EVENT SEATING

(71) Applicant: SEATGEEK, INC., New York, NY (US)

(72) Inventors: Adam SCHNITZER, New York, NY (US); Rebecca James VARNHAGEN, New York, NY (US)

(21) Appl. No.: 16/523,594

(22) Filed: Jul. 26, 2019

(51) Int. Cl. G06Q 30/06; G06Q 10/02; G06Q 20/04; G06Q 30/02

(52) U.S. Cl. CPC G06Q 30/0605; G06Q 30/0202; G06Q 20/045; G06Q 10/02

(57) ABSTRACT

Systems and methods for optimizing tickets sales for an event at an event venue parse ticket sale data to identify seats that are presently unsold and which may be difficult to sell. An attempt is then made to identify an adjacent group of seats that were sold together as a group. If an adjacent group of seats that were sold together is identified, the ticket sale data is again parsed to identify an alternate location for the purchaser of that group of seats. If an alternate location is identified, the system sends an offer to the purchaser of the group of tickets to ask if the purchaser would exchange his existing group of tickets for a group of tickets for the seats at the alternate location. If the purchaser agrees, the ticket sale data is adjusted accordingly. As a result, the seats located adjacent to the unsold seats are freed up for sale as a group with the previously unsold seats.

### BACKGROUND OF THE INVENTION

The invention is related to event ticket sales systems. The event could be virtually any sort of event where tickets for specific seats at an event venue are sold in advance of the event. The invention relates to ways of optimizing ticket sales by re-arranging the locations at which various parties will sit to free up blocks of contiguous seats that are more likely to sell than single seats, or small numbers of contiguous seats.

In many cases, tickets for seats at an event venue for a specific event are available for purchase far in advance of the actual event. In some instances, tickets are available for purchase at a box office that is located at the event venue. More commonly, however, tickets are purchased via the Internet from a website maintained by an event promotor, the venue operator, a ticketing platform or a ticket reseller. Often the website used by a purchaser will provide a depiction of the event venue, and the seats within the event venue that are available for purchase. As a result, a purchaser often is able to identify exactly the seats for which he is buying tickets, and the relationship of those seats to the point of interest in the event venue. In some instances, the purchaser may be purchasing a general admission ticket that allows the purchaser access to an area within an event venue. In that event, the purchaser may also be able to identify the area on a map of the event venue to which the purchaser will be admitted for such a general admission ticket.

Typically, tickets for seats for an event at an event venue will sell over an extended period of time. Also, it is common for tickets to sell in groups of two, four or more, for contiguous seats, because people often attend an event as part of a couple or group, and because people attending as a group wish to sit together. Because of these factors, it is common for individual seats to remain unsold. For example, if there is a row of six seats in a section of an event venue, and a group of five people who are attending the event together purchase five of those seats, the sixth seat at the end of the row may remain unsold. Similar issues can result in single seats or odd numbered groups of contiguous seats remaining unsold. It is actually uncommon for a person to attend certain types of events alone. Thus, sales of single seats are somewhat uncommon.

The single unsold seats and the odd numbered groups of unsold seats represent a loss of income to the event promotor or the event venue. Thus, it would be desirable to find a way to minimize the number of seats that remain unsold.

### BRIEF DESCRIPTION OF THE DRAWINGS

FIG. 1 is a diagram of a ticket sales environment which could be utilized by systems and methods embodying the invention;

FIG. 2 is a diagram of selected elements of a ticketing platform;

FIG. 3 is a diagram of an event venue;

FIGS. 4A and 4B illustrate one example of how tickets for seats at an event venue could be re-arranged to increase the chances that tickets for more of the available seats will be sold;

FIGS. 5A and 5B illustrate another example of how tickets for seats at an event venue could be re-arranged to increase the chances that tickets for more of the available seats will be sold;

FIG. 6 illustrates various elements of a ticket sales optimizer embodying the invention;

FIG. 7 is a flowchart illustrating steps of a method embodying the invention for optimizing ticket sales;

FIG. 8 is a flowchart illustrating steps of another method of optimizing ticket sales; and

FIG. 9 is a diagram of a computer system and associated peripherals which could embody the invention, or which could be used to practice methods embodying the invention.

### DETAILED DESCRIPTION OF PREFERRED EMBODIMENTS

The following detailed description of preferred embodiments refers to the accompanying drawings, which illustrate specific embodiments of the invention. Other embodiments having different structures and operations do not depart from the scope of the present invention.

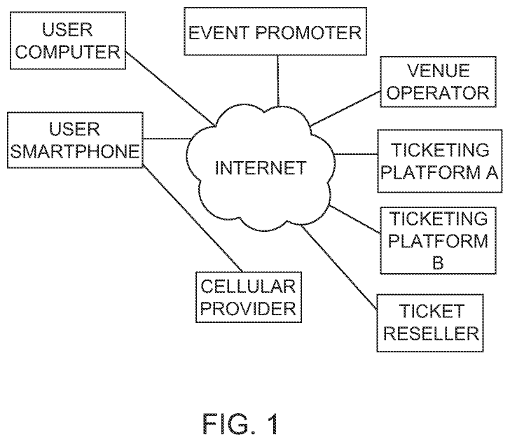

FIG. 1 illustrates an environment in which tickets for seats for an event at an event venue are sold. The environment includes an event promoter 10 that is responsible for setting up events at the event venue. The event promoter 10 may sell tickets for events at the event venue directly to purchasers via one or more ticket sale websites, via one or more box offices or retail locations, or via other means.

The event promoter 10 may also sell tickets to events at the event venue through ticketing platform A and/or ticketing platform B. Each ticketing platform may also operate one or more websites to sell tickets. Also, each ticketing platform may sell tickets via one or more retail locations.

A ticket reseller 26 may also sell tickets for seats for an event at the event venue. Often a ticket reseller 26 will purchase tickets from the event promotor 10 and/or a ticketing platform 22/24, and then attempt to resell the tickets to the purchasing public at a profit. A ticket reseller 26 could resell tickets via one or more websites and/or at retail locations.

The venue operator 20 of the venue at which the event is held may also sell tickets to the event. In some instances, an event promotor 10 and the venue operator 20 may share responsibility for selling tickets to an event.

For purposes of the invention, the type of the event venue is not important. The event venue could be a sports arena or stadium, a concert hall, a theater that hosts plays and musicals, or any other type of event venue for which tickets for specific seats and/or for general admission to the event venue are sold to the purchasing public.

Similarly, the type of the event is not important to the invention. The event could be a sporting event, a concert, a play or musical, a lecture, or any other sort of event where tickets for specific seats and/or for general admission to the event venue are sold to the purchasing public.

A ticket purchaser may use a user computer 50 connected to the Internet 30 to access a website maintained by an event promoter 10, a venue operator 20, a ticketing platform 22/44 or a ticket reseller 26 to purchase tickets to an event. Similarly, a purchaser could use a user smartphone 52 connected to the Internet 30 and/or a cellular provider 40 to purchase tickets via a website. A purchaser might also utilize a software application on either a user computer 50 or a user smartphone 52 to purchase tickets. The software application could be one that has been provided by an event promoter 10, a venue operator 20, a ticketing platform 22/44 or a ticket reseller 26.

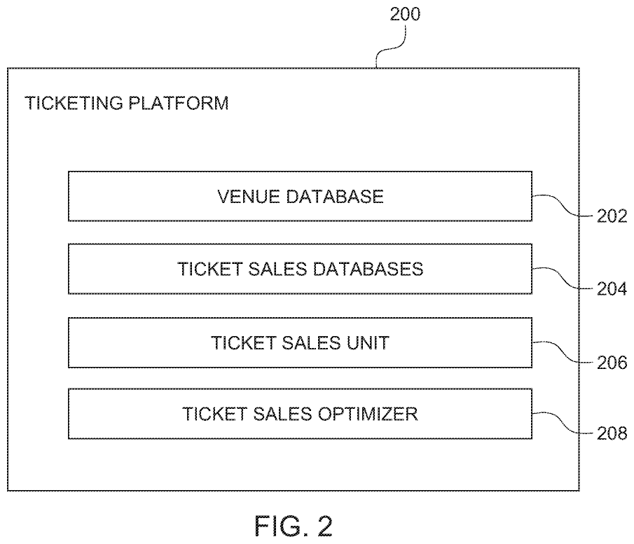

FIG. 2 illustrates selected elements of a ticketing platform 200 that sells tickets for events at event venues. The ticketing platform 200 includes venue databases 202 that contain detailed information about individual event venues. The venue information can include maps or diagrams illustrating the layout and seating arrangements for individual venues. The ticketing platform 200 uses information in the venue databases to present information to purchasers on websites, and to help setup and track ticket sales for events at event venues.

The ticketing platform 200 also includes ticket sales databases 204 that track information about the sales of tickets to individual events at event venues. The ticket sales databases 204 can include information about the tickets that have been sold, the prices at which they were sold, an identity of the party that purchased each ticket, information about the purchasers, as well as other information. The information about the purchaser of a ticket can include contact information that allows the ticketing platform to contact purchasers after tickets have been sold. Also, if a ticket was purchased as part of a group of tickets, information about the group of tickets may also be stored in the ticket sales databases 204.

The ticketing platform 200 further includes a ticket sales unit 206 that is responsible for selling tickets to events at event venues. The ticket sales unit 206 typically includes the systems and infrastructure for setting up and maintaining one or more websites through which tickets are sold. This can include the websites themselves, and the financial transaction systems for receiving payments for ticket sales and for refunding money to purchasers when ticket sales are canceled. The ticket sales unit 206 may also include retail locations for selling tickets. The ticket sales information generated by the ticket sales unit 206 when tickets are sold is then fed to the ticket sales databases 204. Also, when adjustments are made to previously sold tickets, that information also makes it way into the ticket sales databases 204.

The ticketing platform 200 also includes a ticket sales optimizer 208. The ticket sales optimizer 208 attempts to maximize the number of tickets that are sold for each event, to thereby maximize revenue. As will be explained in greater detail below, the ticket sales optimizer 208 attempts to maximize ticket sales by rearranging where individuals and groups of people are seated within an event venue to free up groups of contiguous seats that may be attractive to purchasers.

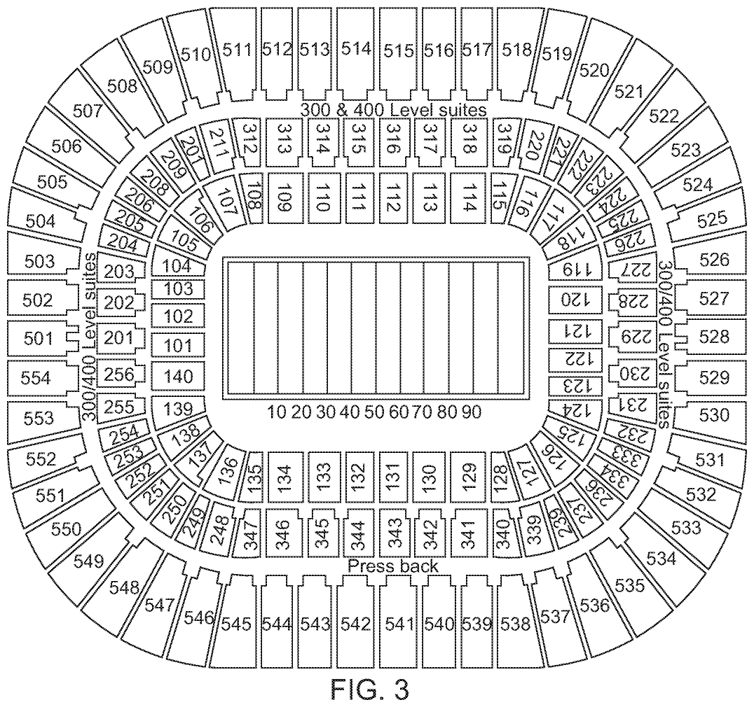

To help explain how a ticket sales optimizer 208 operates to help maximize ticket sales, it is first useful to look at how seats are arranged in a typical event venue. FIG. 3 illustrates a typical large stadium or arena that can host sporting events or large concerts. As depicted in FIG. 3, there are three concentric rings of sections. Each section has multiple rows of sets. Aisles are located on opposite sides of each section to facilitate people getting to and away from the seats in the section.

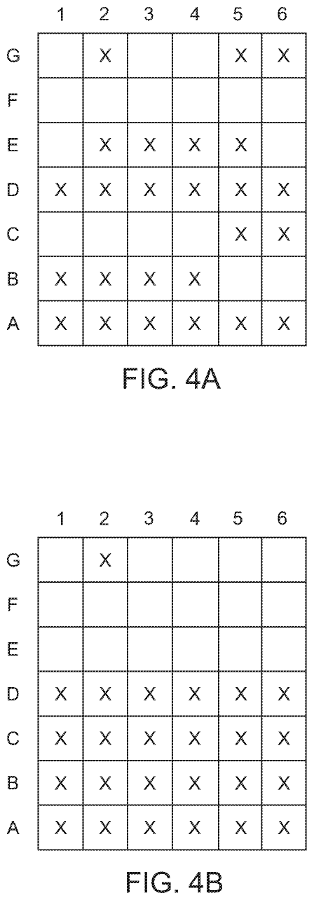

FIGS. 4A and 4B illustrate the seats in section 315 of the venue depicted in FIG. 3. Section 315 has seven rows of seats, with six seats in each row. The rows are labeled with capital letters, and the seats within each row are numbered.

For purposes of this explanation, the seats marked with an X are seats that have already been sold for an event at the venue. If a ticketing platform 200 were responsible for selling tickets to the event, information about which seats are sold and which seats are still available for sale would be recorded in the ticket sales databases 204.

FIG. 4A illustrates the state of ticket sales for seats in section 315 for the event after the tickets have been on sale for a period of time. As shown in FIG. 4A, all seats in row A have been sold, and seats 1-4 of row B have been sold. Seats 5 and 6 of row C have been sold, all the seats in row D have been sold, seats 2-5 of row E have been sold, and seats 2, 5 and 6 of row G have been sold.

The information about the ticket sales may also indicate which tickets were sold together. For purposes of this example, assume that the ticket sales information indicates that tickets for seats E2-E5 were sold as a group to a single purchaser. Assume also that seats G5 and G6 were sold together to the same purchaser.

Because people tend to attend such events in pairs or in larger groups, sales of individual tickets are not common. As a result, it may be difficult to sell tickets for seats E1, E6 and G1. Also, because someone has purchased seat G2, the two available seats G3 and G4 are not as attractive to potential purchasers as two seats would be at the end of a row. The upshot is that it may be quite difficult to sell all the remaining seats in section 315 because of the way sales of seats has progressed to date.

A ticket sales optimizer embodying the invention seeks to rearrange where people are sitting at an event venue to make the remaining unsold seats more attractive to potential purchasers. FIG. 4B illustrates how section 315 would appear after the ticket sales optimizer has acted to relocate certain purchasers.

As noted above, seats E2-E5 were sold together as a group to a single purchaser. Because there are four contiguous seats available in row C, it would be possible to move the people who were planning to sit in seats E2-E5 to seats C1-C4. In fact, this would bring the people closer to the front of the venue, which is likely an attractive move. Indeed, the cost of tickets for seats in row C may be greater than the cost of tickets for seats in row E.

A ticket sales optimizer is configured to identify that it is possible to move people from seats E2-E5 to seats C1-C4. The ticket sales optimizer then causes a communication to be sent to the purchaser of the tickets for seats E2-E5, where the communication offers to move the purchaser to seats C1-C4. That relocation offer could include an offer to make this move without additional charges, even though the seats in row C are more expensive. In some situations, the offer could include a reduction in the price of the tickets that the purchaser already paid, as an added incentive for making the move.

If the purchaser accepts the relocation offer, the ticket sales optimizer would adjust the ticket sale data to reflect that seats E2-E5 are now available for sale, and to reflect that the purchaser now has tickets for seats C1-C4 of section 315. The ticket sales optimizer might also issue new tickets to the purchaser for seats C1-C4 and cancel the tickets the purchaser originally obtained for seats E2-E5.

When the purchaser accepts the relocation offer, it frees up all the seats in row E, as illustrated in FIG. 4B. This makes it much easier to sell all of the seats in row E, as compared to the previous situation where single seats E1 and E6 were for sale.

In some instances, and depending on the terms and conditions under which tickets are sold, the event venue or a ticketing platform may not need to seek approval before moving a ticket purchaser from one location to another within an event venue. In the example given above, it may not be necessary to seek approval from the purchaser of tickets E2-E5 before moving the purchaser to seats C1-C4. Thus, rather than sending an offer to the purchaser of tickets E2-E5, the purchaser may instead simply receive a notification that the purchaser has been moved to seats C1-C4, and the notification may include new tickets and/or new ticketing data.

The ticket sales optimizer may also note that there are two free seats in row B. Recall that seats G5 and G6 were purchased by a single individual. The ticket sales optimizer could cause a communication to be sent to the purchaser of seats G5 and G6, offering to exchange the tickets for those seats for tickets for seats B5 and B6. This would likely be attractive to the purchaser because it will bring them closer to the event, and because the price of tickets in row B is greater than the price of tickets in row G. If the purchaser accepts, the ticket sales optimizer adjusts the sales records accordingly, and it may also issue new tickets for seats B5 and B6. Also, because of this move, four adjacent seats will be available in row G. It will likely be easier to sell four contiguous seats in row G, as opposed to the three seats that were previously available in row G before the move occurred.

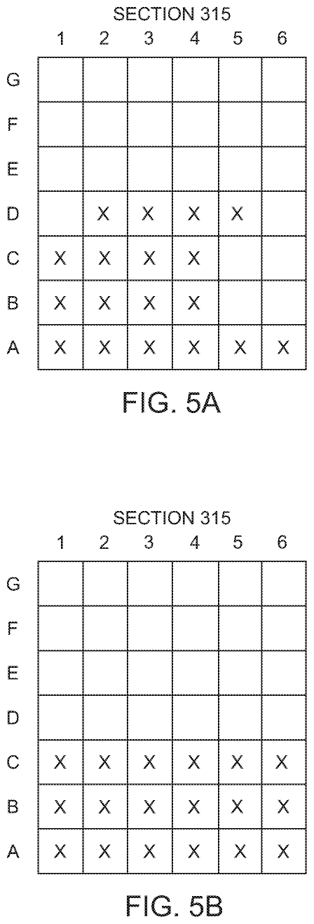

FIGS. 5A and 5B illustrate another example of how a ticket sales optimizer can act to move people to increase the chances that more tickets to an event will be sold. FIG. 5A illustrates an example of how tickets have been sold thus far for a section of an event venue. As shown therein, seats B5 and B6 are available, seats C5 and C6 are available, and seats D1 and D6 are available. For the reasons explained above, it may be quite difficult to sell tickets for seats D1 and D5. Assume for this example that a single purchaser bought the tickets for seats D2-D5.

When presented with a sales pattern as depicted in FIG. 5A, a ticket sales optimizer would cause a communication to be sent to the purchaser of the tickets for seats D2-D5, offering to move the purchaser to seats B5, B6, C5 and C6. Although not all of those seats are in the same row, all four of the seats are together. The offer may include a price reduction to provide a greater incentive to the purchaser to make the move.

If the purchaser accepts the relocation offer, the new ticket sales data will be as depicted in FIG. 5B. Note that all the seats in row D are now available, which makes it much more likely that all of the seats in row D will sell, as compared to the previous situation depicted in Figure SA, where single seats D1 and D6 were unsold.

In the foregoing examples, a ticket sales optimizer rearranged the people sitting in a single section of an event venue to increase the chances that more seats in that section would be sold. However, a ticket sales optimizer is not limited to moving people within a single section. A purchaser that has purchased tickets for seats in one section could be moved to a completely different section within the event venue. Indeed, offering to move a purchaser to seats in a more desirable section could help to convince the purchaser to accept a relocation offer.

In the case of general admission tickets, the ticket sales optimizer may seek to move a purchaser from one general admission area to another, or from a general admission area to a specific seat in the event venue. As with the foregoing examples, the ticket sales optimizer could simply inform the purchaser that he has been moved. Alternatively, the ticket sales optimizer may send a communication to the ticket purchaser offering to move the purchaser to a new location, either with or without some sort of an incentive.

If a ticket purchaser is offered an incentive to move to a new location in an event venue, the incentive could take the form of moving the purchaser to seats that are more expensive for no additional cost. Alternatively, a direct financial incentive could be offered in the form of a rebate or refund of part of the ticket price they already paid, or in terms of a direct payment for making the move. Also, non-financial incentives might also be offered, such as offering the ticket purchaser field passes to meet the players of a sporting event, or backstage passes to a concert event.

In some embodiments, if a ticket sales optimizer wishes to move a ticket purchaser to a new location in an event venue, the initial communication to the ticket purchaser may include a question about what sort of incentive the ticket purchaser would accept for making the move. Based on the ticket purchaser's response to that question, the ticket sales optimizer may or may not choose to move forward with the move.

A ticket sales optimizer might even offer to move a purchaser to not only a different location within the venue, but to a different event altogether. For example, if the event venue is a theater hosting a play, the ticket sales optimizer might offer to exchange a purchaser's tickets for a first showing of the play for tickets to a second, different showing of the play.

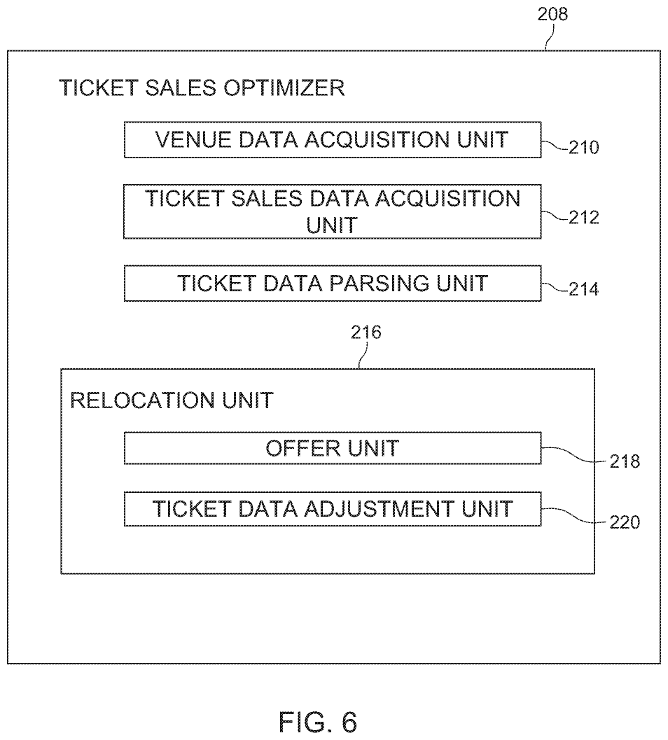

FIG. 6 illustrates some elements of a ticket sales optimizer 208 embodying the invention. As shown in FIG. 6, the ticket sales optimizer 208 includes a venue data acquisition unit 210 that would obtain data about individual event venues. The information could include the layout of the venues and the seating arrangements. The venue data acquisition unit 210 could obtain such information from venue databases 202 of a ticketing platform, or from alternate sources such as a venue operator 20, an event promotor 10 or other third-party sources.

The ticket sales optimizer 208 also includes a ticket sales data acquisition unit 212 that obtains data about ticket sales for events at event venues. The information acquired can include information about which tickets have been sold and which are still available, the prices at which tickets sold and the prices currently being offered for available tickets, the identity of who purchased tickets and corresponding contact information, information about which tickets were sold together as a group, as well as other information. The ticket sales information may also include information about sales of general admission tickets.

The ticket sales optimizer 208 also includes a ticket data parsing unit 214 that parses or reviews acquired ticket sales data to identify seats that are still available for sale and that are likely to be difficult to sell. An example of such seats are seats E1 and E6 in FIG. 4A.

The ticket data parsing unit 214 also parses or reviews acquired ticket sale data to identify a block of one or more sold seats that are adjacent to a seat that is still available and that is likely to be difficult to sell. Those seats are identified because it might be possible to move people in those seats to alternate locations to free up a larger contiguous block of seats that includes one of the difficult to sell seats. An example of such seats are seats E2-E5 in FIG. 4A. Parsing the ticket sale data for this purpose may include reviewing the data to identify tickets to contiguous seats that were sold as a group to a single purchaser.

The ticket data parsing unit 214 also parses or reviews ticket sales data to identify candidate blocks of one or more available seats that people could be moved to in order to free up seats adjacent to a difficult to sell seat. An example would be seats C1-C4 in FIG. 4A.

The ticket sales optimizer 208 also includes a relocation unit 216 that attempts to relocate people that have already purchased tickets to free up seats adjacent to hard to sell seats. The relocation unit 216 includes an offer unit 218 that creates relocation offers that are sent to purchasers offering to relocate the purchasers to alternate seats. Also, as mentioned above, the relocation unit 216 may not need to make offers to ticket purchasers in order to relocate the ticket purchasers. Instead, the offer unit 218 may simply inform a ticket purchaser that he has been moved to a new location.

The relocation unit 216 make take various factors into account when deciding whether to move a ticket purchaser to a new location, and/or whether to make an offer to a ticket purchaser to be moved to a new location. Those factors can include the estimated likelihood that the purchaser will accept the offer. That estimated likelihood of acceptance can be based on the desirability and/or price of the purchaser's current seats as compared to the desirability and/or price of the new seats. The estimated likelihood of acceptance may also be based on past behavior of the ticket purchaser in accepting or rejecting similar offers.

The estimated likelihood of acceptance may also be based on whether a large group of seats would be broken up into two or more smaller groups of seats upon making the move. For example, if a group of four seats were broken up into two groups of two seats. Depending on how this is accomplished, it could have different effects on the likelihood of acceptance. If the group of four is relocated to two groups of two seats, and the two groups of two seats are directly adjacent to one another in two adjacent rows, it would result in the four people finding it easier to interact with one another, which is likely desirable, increasing the likelihood of acceptance. If the two groups of two seats are located far apart from one another, this would likely be viewed as undesirable, decreasing the likelihood of acceptance.

The above are only a few examples of factors that could be taken into account in estimating whether a ticket purchaser is likely to accept a relocation offer. Other factors would also be apparent to those of ordinary skill in the art, and those other factors could also be taken into account.

The relocation unit 216 might also take into account an estimated increase in ticket revenue if a ticket purchaser were to accept a relocation offer. the estimated increase in ticket revenue would be based on anticipated additional ticket sales in the event a relocation of purchased seats frees up seats that will be subsequently purchased by other parties. The estimated increase in ticket revenue may also be taken into consideration by the offer unit 218 when deciding what sort of incentive to offer to a ticket purchaser to accept a relocation offer.

The offer unit 218 may also take into consideration the price the purchaser paid for his current seats, and the cost of the tickets for the alternate seats. The offer unit 218 may offer a discount or some other form of financial incentive to help convince the purchaser to accept a relocation offer. This could include a further discount on tickets to another event, or some other type of financial incentive. Further, the offer unit 218 may offer a non-financial incentive to a ticket purchaser, such as field passes or backstage passes.

If a purchaser accepts a relocation offer, or in instances where the purchaser is simply informed that the purchaser has been moved, a ticket data adjustment unit 220 adjusts the ticket sales data accordingly. This can include communicating with third parties to inform them of the change. This can also include cancelling previously issued tickets and issuing new tickets.

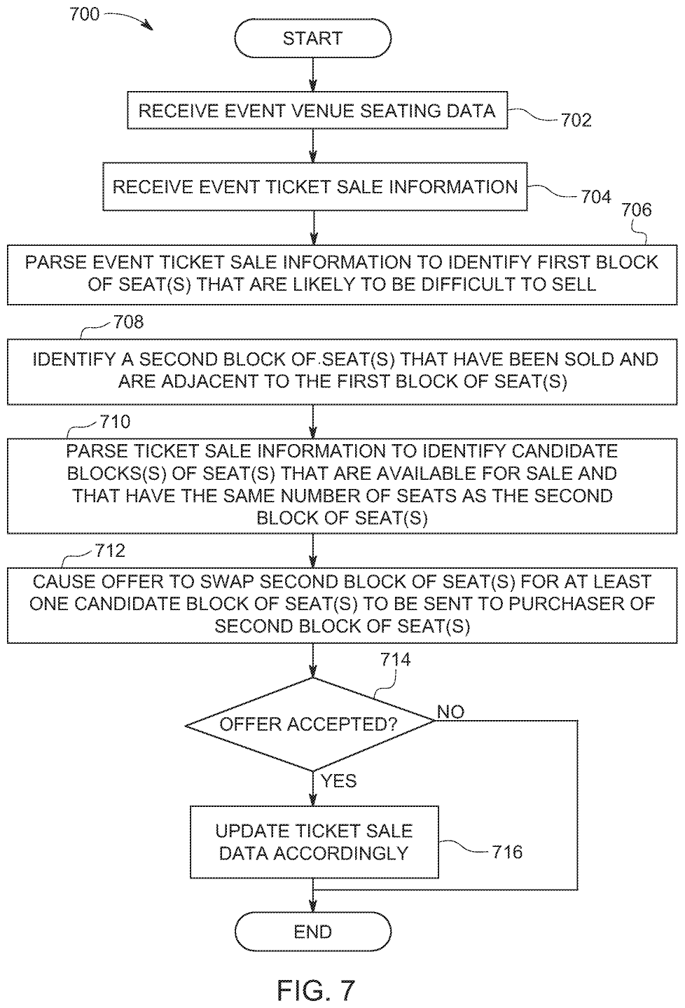

FIG. 7 illustrates steps of a method that would be performed by a ticket sales optimizer to increase the chances that more tickets to an event will be sold. The method 700 begins and proceeds to step 702 where a venue data acquisition unit 210 obtains information about a venue that will host an event. The method proceeds to step 704 where the ticket sales data acquisition unit 212 obtains ticket sales data for an event.

The method then proceeds to step 706 where the ticket data parsing unit 214 parses the obtained ticket sales data to identify a first block of one or more seats that are still available for sale and that are likely to be difficult to sell. The method then proceeds to step 708 where the ticket data parsing unit 214 parses the obtained ticket sales data to identify a second block of one or more seats that have been sold to a ticket holder and that are adjacent to the first block of one or more seats. Next, in step 710 the ticket data parsing unit parses the obtained ticket sales data to identify at least one candidate block of one or more seats that are still available for sale and that have at least the same number of seats as the second block of one or more seats. In some instances, multiple candidate blocks of one or more seats may be identified.

The method then proceeds to step 712, where the offer unit 218 causes a relocation offer to be sent to the individual that holds the tickets for the second block of one or more seats. The relocation offer is an offer to exchange the tickets the ticket holder currently has for the second block of one or more seats for tickets for at least one of the candidate blocks of one or more seats. If more than one candidate block was identified in step 710, the offer may include multiple candidate blocks. The relocation offer may also include some sort of financial incentive to convince the ticket holder to accept the offer.

Next, in step 714 a check is performed to determine whether the ticket holder has accepted the offer. If not, the method ends. If the ticket holder accepts the offer, the method proceeds to step 716 where the ticket data adjustment unit 220 adjusts the ticket sale data accordingly. The ticket data adjustment unit 220 may also cancel the previously issued tickets and issue new tickets.

Note, a method as depicted in FIG. 7 could be performed in an iterative fashion. Once a first block of seats is relocated, the entire method could be re-performed in light of the new configuration of sold seats in the event venue. Indeed, a method as depicted in FIG. 7 could be performed again and again over time, as more tickets are sold, and as certain ticket purchasers are re-located to free up potentially desirable blocks of seats.

A relocation offer sent to a purchaser could take many different forms. In some instances, the relocation offer sent by the offer unit 218 could take the form of an email message sent to the purchaser's email address. In other instances, the offer could be a text message. An email or a text message could lay out the terms of the offer and include a link that the purchaser could follow to access a page of a website that includes the offer details, and the ability to accept the offer.

In some embodiments, the offer could take the form of a push notification. If the user selects the push notification, or a “YES” button in the push notification, a software application provided by an event promoter, a ticketing platform, a ticket reseller or a venue operator could be loaded and run. The purchaser could then interact with the software application to review details of the relocation offer, and to accept or reject the offer.

In still other embodiments, the offer could be contained within an in-application message that is delivered to the purchaser when the purchaser is using a software application provided by an event promoter, a ticketing platform, a ticket reseller or a venue operator. The purchaser could then interact with the software application to review terms of the offer and to accept or reject the offer.

A relocation offer could also be made by a customer service agent calling the ticket purchaser to make the offer. When a customer service agent makes a relocation offer to a ticket purchaser, the customer service agent could offer a first level of incentive for the relocation to the purchaser, and if the purchaser does not accept, the customer service agent could make a second offer of better terms. This process could repeat until the purchaser accepts, or until the customer service agent has exhausted his available options. Of course, a relocation offer could also take various other forms, so long as the offer is able to communicate the proposed terms to the purchaser. The offer could also indicate how the purchaser is to go about accepting the offer.

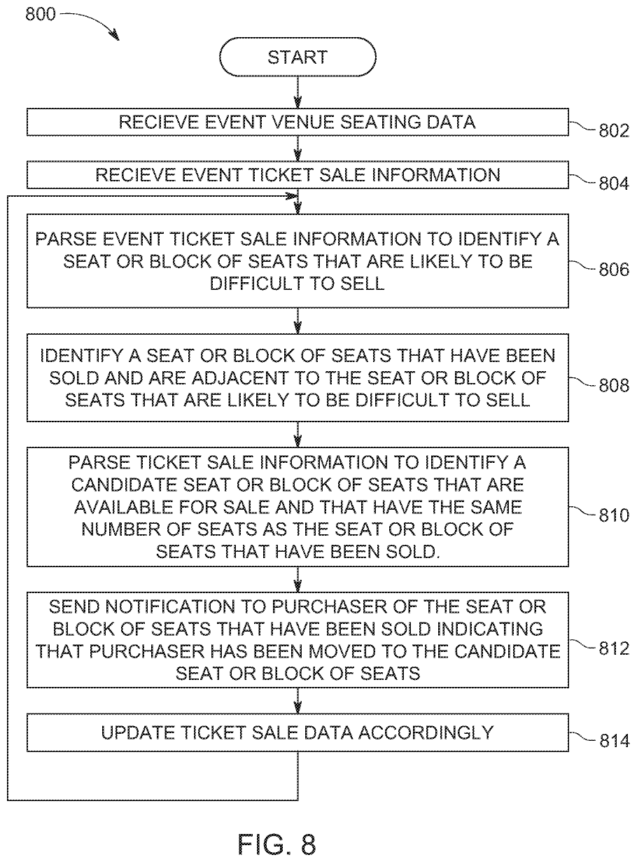

FIG. 8 illustrates steps of another method that would be performed by a ticket sales optimizer to increase the chances that more tickets to an event will be sold. The method 800 begins and proceeds to step 802 where a venue data acquisition unit 210 obtains information about a venue that will host an event. The method proceeds to step 804 where the ticket sales data acquisition unit 212 obtains ticket sales data for an event.

The method then proceeds to step 806 where the ticket data parsing unit 214 parses the obtained ticket sales data to identify a seat or a block of seats that are still available for sale and that are likely to be difficult to sell. The method then proceeds to step 808 where the ticket data parsing unit 214 parses the obtained ticket sales data to identify a seat or a block of seats that have been sold to a ticket holder and that are adjacent to the seat or block of seats that are likely to be difficult to sell. Next, in step 810 the ticket data parsing unit 214 parses the obtained ticket sales data to identify a candidate seat or block of seats that are still available for sale and that have at least the same number of seats as the seat or block of seats that have been sold. In some instances, multiple candidate seats or blocks seats may be identified.

The method then proceeds to step 812, where the offer unit 218 sends a notification to the purchaser of the seat or block of seats that have been sold indicating that the purchaser has been moved to the candidate seat or block of seats. Thus, in this method, no relocation offer is sent to the purchaser. Instead, the purchaser is simply informed that the purchaser has been moved to a new location in the event venue.

The method then proceeds to step 814 where the ticket data adjustment unit 220 adjusts the ticket sale data accordingly. The ticket data adjustment unit 220 may also cancel the previously issued tickets and issue new tickets. The method then loops back to step 806, and steps 806-814 are performed again in light of the new seating configuration. Steps 806-814 can be repeatedly performed multiple times until the check performed in step 806 is unable to identify a seat or block of seats that are likely to be difficult to sell, or until the check performed in step 808 is unable to identify sold seats next to a difficult to sell seat that could be moved, or until the check performed in step 810 fails to identify a candidate seat or block of seats to which a ticket purchaser could be relocated.

In a method as illustrated in FIG. 8, there may be constraints on the type of seats to which a ticket purchaser could be relocated. For example, step 810 may involve only looking for candidate seats that are of the same quality or price, or better, than the seats the ticket purchaser currently holds. Another factor that may be considered is whether the candidate seats include the same benefits as the current seats, such as access to VIP areas or concessions. Other constraints in how a ticket purchaser can be relocated may also be used to decide whether to move a ticket purchaser.

A ticket sales optimizer 208 as illustrated in FIG. 6 is shown as being a part of a ticketing platform 200, as illustrated in FIG. 2. However, a ticket sales optimizer could also be utilized by an event promotor, a ticket reseller or a venue operator. Thus, a ticket sales optimizer may be part of the computer support systems maintained and run by those parties. Alternatively, a ticket sales optimizer might be a standalone service that is used by event promotors, ticketing platforms, ticket resellers or venue operators.

In order to operate, a ticket sales optimizer must have access to ticket sales data that indicates which seats within all or a portion of an event venue have been sold, and/or what tickets have been sold for general admission, and which seats are still available. If a single entity, such as an event promotor, has access to the ticket sales data for an entire event venue, this would provide the ticket sales optimizer with maximum flexibility in moving people to increase the chances that more tickets will be sold. However, it is not necessary for the ticket sales optimizer to have access to ticket sales data for all of the event venue.

For example, in some instances an event promoter may have responsibility for selling half of the tickets in an event venue and a ticketing platform will have responsibility for selling the other half of the tickets. Under these circumstances, the event promotor could engage the services of a ticket sales optimizer using the tickets sales data that exists for its half of the event venue.

The party that uses or operates a ticket sales optimizer, or that engages the services of an independent ticket sales optimizer, may be able to place constraints on the relocation offers that are made by the ticket sales optimizer. For example, the operator could specify that purchasers are not to be offered new tickets that cost more than 20% more than the tickets they originally purchased. If there are multiple grades of sections that are indicative of their desirability, a constraint may be placed on how much a purchaser could be upgraded via a relocation offer. Other similar constraints may be placed on relocation offers.

A ticket sales optimizer may be configured to make multiple relocation offers to the same purchasers over time. This could result in the ticket sales optimizer making a first relocation offer to a purchaser that includes mildly favorable terms. If the purchaser declines the initial relocation offer, the ticket sales optimizer could make a second relocation offer to the purchaser that includes more favorable terms.

A ticket sales optimizer might also control when relocation offers are sent. For example, a ticket sales optimizer could make a first relocation offer to a purchaser with mildly favorable terms four weeks before the event. If the purchaser declines the offer, the ticket sales optimizer might make a second relocation offer with more favorable terms one week before the event. The ticket sales optimizer would wait three weeks before making the second relocation offer to see if some of the unsold seats are ultimately sold during the intervening three-week period. If not, the second offer with more favorable terms is then made.

A ticket sales optimizer could be used to relocate season ticket holders, partial season ticket holders, or purchasers of ticket packages. This would be quite efficient as one relocation offer and acceptance will make it possible to sell more tickets to multiple different events. That said, a ticket sales optimizer could also be used for one-off events.

The present invention may be embodied in methods, apparatus, electronic devices, and/or computer program products. Accordingly, the invention may be embodied in hardware and/or in software (including firmware, resident software, micro-code, and the like), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus or device. More specific examples (a non-exhaustive list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as JavaScript, Java, Swift or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

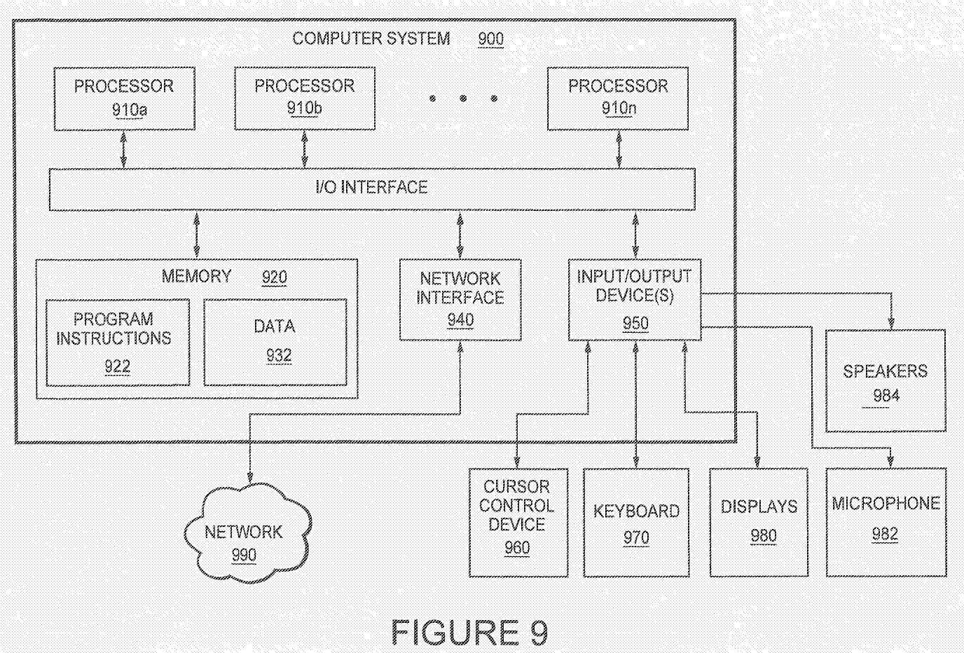

FIG. 9 depicts a computer system 900 that can be utilized in various embodiments of the present invention to implement the invention according to one or more embodiments. The various embodiments as described herein may be executed on one or more computer systems, which may interact with various other devices. One such computer system is the computer system 900 illustrated in FIG. 9. The computer system 900 may be configured to implement the methods described above. The computer system 900 may be used to implement any other system, device, element, functionality or method of the above-described embodiments. In the illustrated embodiments, the computer system 900 may be configured to implement the disclosed methods as processor-executable executable program instructions 922 (e.g., program instructions executable by processor(s) 910) in various embodiments.

In the illustrated embodiment, computer system 900 includes one or more processors 910a-910n coupled to a system memory 920 via an input/output (I/O) interface 930. Computer system 900 further includes a network interface 940 coupled to I/O interface 930, and one or more input/output devices 950, such as cursor control device 960, keyboard 970, display(s) 980, microphone 982 and speakers 984. In various embodiments, any of the components may be utilized by the system to receive user input described above. In various embodiments, a user interface may be generated and displayed on display 980. In some cases, it is contemplated that embodiments may be implemented using a single instance of computer system 900, while in other embodiments multiple such systems, or multiple nodes making up computer system 900, may be configured to host different portions or instances of various embodiments. For example, in one embodiment some elements may be implemented via one or more nodes of computer system 900 that are distinct from those nodes implementing other elements. In another example, multiple nodes may implement computer system 900 in a distributed manner.

In different embodiments, the computer system 900 may be any of various types of devices, including, but not limited to, a personal computer system, desktop computer, laptop, notebook, or netbook computer, a portable computing device, a mainframe computer system, handheld computer, workstation, network computer, a smartphone, a camera, a set top box, a mobile device, a consumer device, video game console, handheld video game device, application server, storage device, a peripheral device such as a switch, modem, router, or in general any type of computing or electronic device.

In various embodiments, the computer system 900 may be a uniprocessor system including one processor 910, or a multiprocessor system including several processors 910 (e.g., two, four, eight, or another suitable number). Processors 910 may be any suitable processor capable of executing instructions. For example, in various embodiments processors 910 may be general-purpose or embedded processors implementing any of a variety of instruction set architectures (ISAs). In multiprocessor systems, each of processors 910 may commonly, but not necessarily, implement the same ISA.

System memory 920 may be configured to store program instructions 922 and/or data 932 accessible by processor 910. In various embodiments, system memory 920 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 920. In other embodiments, program instructions and/or data may be received, sent or stored upon different types of computer-accessible media or on similar media separate from system memory 920 or computer system 900.

In one embodiment, I/O interface 930 may be configured to coordinate I/O traffic between processor 910, system memory 920, and any peripheral devices in the device, including network interface 940 or other peripheral interfaces, such as input/output devices 950. In some embodiments, I/O interface 930 may perform any necessary protocol, timing or other data transformations to convert data signals from one component (e.g., system memory 920) into a format suitable for use by another component (e.g., processor 910). In some embodiments, I/O interface 930 may include support for devices attached through various types of peripheral buses, such as a variant of the Peripheral Component Interconnect (PCI) bus standard or the Universal Serial Bus (USB) standard, for example. In some embodiments, the function of I/O interface 930 may be split into two or more separate components, such as a north bridge and a south bridge, for example. Also, in some embodiments some or all of the functionality of I/O interface 930, such as an interface to system memory 920, may be incorporated directly into processor 910.

Network interface 940 may be configured to allow data to be exchanged between computer system 900 and other devices attached to a network (e.g., network 990), such as one or more external systems or between nodes of computer system 900. In various embodiments, network 990 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 940 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 950 may, in some embodiments, include one or more display terminals, keyboards, keypads, touchpads, scanning devices, voice or optical recognition devices, or any other devices suitable for entering or accessing data by one or more computer systems 900. Multiple input/output devices 950 may be present in computer system 900 or may be distributed on various nodes of computer system 900. In some embodiments, similar input/output devices may be separate from computer system 900 and may interact with one or more nodes of computer system 900 through a wired or wireless connection, such as over network interface 940.

In some embodiments, the illustrated computer system may implement any of the operations and methods described above, such as the methods illustrated by the flowcharts of FIGS. 7 and 8. In other embodiments, different elements and data may be included.

Those skilled in the art will appreciate that the computer system 900 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 900 may also be connected to other devices that are not illustrated, or instead ay operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 900 may be transmitted to computer system 900 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or nonvolatile media such as RAM (e.g., SDRAM, DDR, RDRAM, SRAM, and the like), ROM, and the like.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A method of optimizing ticket sales for an event, comprising:
receiving an electronic representation of seating for an event venue;
receiving ticket sale information for the event that indicates which seats within the event venue have been sold and which seats are still available for sale;
parsing the ticket sale information with one or more processors to identify a first block of one or more seats that are still available for sale and that are likely to be difficult to sell wherein identifying the first block of one or more seats comprises at least one of identifying a single seat that is still available for sale and that is located between two seats in a same row that have already been sold, identifying three adjacent seats that are still available for sale and that are located adjacent to a seat in a same row that has already been sold and/or identifying a single seat that is still available for sale, that is at an end of a row, and that is located adjacent to a seat in a same row that has already been sold;
identifying a second block of one or more seats that are adjacent to the first block of one or more seats and that have already been sold to a first ticket holder;
parsing the ticket sale information with one or more processors to identify at least one candidate block of one or more seats that are still available for sale and that have at least a same number of seats as the second block of one or more seats; and
causing a communication to be sent to the first ticket holder, where the communication includes at least one of an offer to exchange tickets for the second block of one or more seats for tickets for the at least one candidate block of one or more seats and an indication that tickets for the second block of one or more seats have been exchanged for tickets for the at least one candidate block of one or more seats.

2. The method of claim 1, wherein parsing the ticket sale information with the one or more processors to identify the at least one candidate block of one or more seats comprises identifying a plurality of candidate blocks of one or more seats that are still available for sale and that have at least the same number of seats as the second block of one or more seats.

3. The method of claim 1, further comprising designating any of the at least one candidate blocks of one or more seats for which tickets are as expensive or more expensive than tickets for the second block of one or more seats as desirable blocks of one or more seats, and wherein the communication includes an offer to exchange the tickets for the second block of one or more seats for tickets for at least one desirable block of one or more seats.

4. The method of claim 1, wherein the offer to exchange the tickets for the second block of one or more seats for the tickets for the at least one candidate block of one or more seats offers the tickets for the at least one candidate block of one or more seats at below market rates.

5. The method of claim 1, wherein a cost of the tickets for the at least one candidate block of one or more seats is the same as or greater than a cost of the tickets for the second block of one or more seats.

6. The method of claim 5, wherein the offer to exchange the tickets for the second block of one or more seats for the tickets for the at least one candidate block of one or more seats offers the tickets for the at least one candidate block of one or more seats at below market rates.

7. The method of claim 1, wherein parsing the ticket sale information with the one or more processors to identify the first block of one or more seats that are still available for sale comprises identifying a single seat that is still available for sale and that is located between two seats in a same row that have already been sold.

8. The method of claim 1, wherein parsing the ticket sale information with the one or more processors to identify the first block of one or more seats that are still available for sale comprises identifying three adjacent seats that are still available for sale and that are located adjacent to a seat in a same row that has already been sold.

9. The method of claim 1, wherein parsing the ticket sale information with the one or more processors to identify the first block of one or more seats that are still available for sale comprises identifying a single seat that is still available for sale, that is at an end of a row and that is located adjacent to a seat in a same row that has already been sold.

10. The method of claim 1, wherein the communication sent to the first ticket holder includes the offer to exchange the tickets for the second block of one or more seats for the tickets for the at least one candidate block of one or more seats, and wherein the method further comprises:
receiving a communication from the first ticket holder that indicates the first ticket holder has accepted the offer to exchange the tickets for the second block of one or more seats for tickets for a candidate block of one or more seats;
causing a status of the second block of one or more seats to be changed to indicate that the second block of one or more seats are again available for sale along with the first block of one or more seats; and
causing a status of the candidate block of one or more seats to be changed to indicate that the candidate block of one or more seats have been sold.

11. The method of claim 1, wherein parsing the ticket sale information with the one or more processors to identify the at least one candidate block of one or more seats that are still available for sale comprises parsing the ticket sale information to identify at least one candidate block of one or more seats that has a same seating configuration as the second block of one or more seats.

12-23. (canceled)

24. A system configured to optimize ticket sales for an event, comprising:
one or more processors that are running software which configures the one or more processors to perform a method comprising:
receiving an electronic representation of seating for an event venue;
receiving ticket sale information for the event that indicates which seats within the event venue have been sold and which seats are still available for sale;
parsing the ticket sale information with the one or more processors to identify a first block of one or more seats that are still available for sale and that are likely to be difficult to sell wherein identifying a first block of one or more seats comprising at least one of identifying a single seat that is still available for sale and that is located between two seats in a same row that have already been sold, identifying three adjacent seats that are still available for sale and that are located adjacent to a seat in a same row that has already been sold and/or identifying a single seat that is still available for sale, that is at an end of a row, and that is located adjacent to a seat in a same row that has already been sold;
identifying a second block of one or more seats that are adjacent to the first block of one or more seats and that have already been sold to a first ticket holder;
parsing the ticket sale information with the one or more processors to identify at least one candidate block of one or more seats that are still available for sale and that have at least a same number of seats as the second block of one or more seats; and
causing a communication to be sent to the first ticket holder, where the communication includes at least one of an offer to exchange tickets for the second block of one or more seats for tickets for the at least one candidate block of one or more seats and an indication that tickets for the second block of one or more seats have been exchanged for tickets for the at least one candidate block of one or more seats.

25. The system of claim 24, wherein parsing the ticket sale information with the one or more processors to identify the at least one candidate block of one or more seats comprises identifying a plurality of candidate blocks of one or more seats that are still available for sale and that have at least the same number of seats as the second block of one or more seats.

26. The system of claim 24, wherein the method performed by the one or more processors further comprises designating any of the at least one candidate blocks of one or more seats for which tickets are as expensive or more expensive than tickets for the second block of one or more seats as desirable blocks of one or more seats, and wherein the communication includes an offer to exchange the tickets for the second block of one or more seats for tickets for at least one desirable block of one or more seats.

27. The system of claim 24, wherein the offer to exchange the tickets for the second block of one or more seats for the tickets for the at least one candidate block of one or more seats offers the tickets for the at least one candidate block of one or more seats at below market rates.

28. The system of claim 24, wherein a cost of the tickets for the at least one candidate block of one or more seats is the same as or greater than a cost of the tickets for the second block of one or more seats.

29. The system of claim 28, wherein the offer to exchange the tickets for the second block of one or more seats for the tickets for the at least one candidate block of one or more seats offers the tickets for the at least one candidate block of one or more seats at below market rates.

30. The system of claim 24, wherein parsing the ticket sale information with the one or more processors to identify the first block of one or more seats that are still available for sale comprises identifying a single seat that is still available for sale and that is located between two seats in a same row that have already been sold.

31. The system of claim 24, wherein parsing the ticket sale information with the one or more processors to identify the first block of one or more seats that are still available for sale comprises identifying three adjacent seats that are still available for sale and that are located adjacent to a seat in a same row that has already been sold.

32. The system of claim 24, wherein parsing the ticket sale information with the one or more processors to identify the first block of one or more seats that are still available for sale comprises identifying a single seat that is still available for sale, that is at an end of a row and that is located adjacent to a seat in a same row that has already been sold.

33. The system of claim 24, wherein the communication sent to the first ticket holder includes the offer to exchange the tickets for the second block of one or more seats for the tickets for the at least one candidate block of one or more seats, and wherein the method performed by the one or more processors further comprises:
receiving a communication from the first ticket holder that indicates the first ticket holder has accepted the offer to exchange the tickets for the second block of one or more seats for tickets for a candidate block of one or more seats;
causing a status of the second block of one or more seats to be changed to indicate that the second block of one or more seats are again available for sale along with the first block of one or more seats; and
causing a status of the candidate block of one or more seats to be changed to indicate that the candidate block of one or more seats have been sold.

34. The system of claim 24, wherein parsing the ticket sale information with the one or more processors to identify the at least one candidate block of one or more seats that are still available for sale comprises parsing the ticket sale information to identify at least one candidate block of one or more seats that has a same seating configuration as the second block of one or more seats.
